(19) United States
(12) Patent Application Publication
(10) Pub. No.: US 2008/0131554 A1
(43) Pub. Date: Jun. 5, 2008

(54) Mold having plural cavities for manufacturing different-sized plastic frames

(75) Inventor: Zhi-Feng Fu, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOCOM TECHNOLOGY (SHENZHEN) CO., LTD.:INNOLUX DISPLAY CORP.

(21) Appl. No.: 11/999,075

(22) Filed: Dec. 4, 2007

(30) Foreign Application Priority Data
Dec. 1, 2006 (TW) 95221245

(51) Int. Cl. B29C 45/32

(52) U.S. Cl. 425/556; 425/588

(57) ABSTRACT

An exemplary mold for manufacturing different-sized plastic frames simultaneously includes a first mold half and a second mold half. The first and second mold halves cooperatively define a first molding chamber and a second molding chamber, and the first molding chamber surrounds the second molding chamber.

### FIELD OF THE INVENTION

The present invention relates to a mold that includes a mold chamber surrounded by another different-sized mold chamber, so that different-sized plastic frames can be simultaneously manufactured.

### BACKGROUND

Many products such as liquid crystal displays (LCDs) are housed in a chassis such as a plastic frame. For example, a typical liquid crystal display requires an accompanying backlight module and a plastic frame for accommodating the backlight module. The plastic frame is generally manufactured by an injection molding method.

Referring to FIG. 6 to FIG. 8, a typical mold 1 for manufacturing a plastic frame (not shown) includes an upper mold half 11 and a lower mold half 13 separated by an imaginary parting plane 100 therebetween. The upper mold half 11 includes a filler opening 119, a runner 116, and an upper cavity 118 defined therein. The lower mold half 13 includes a lower cavity 138 defined therein. When the upper and lower mold halves 11, 13 are attached together, the upper and lower cavities 118, 138 cooperatively define a molding chamber 18 corresponding to a shape of the plastic frame.

In manufacturing the plastic frame, the molding chamber 18 is filled up with melted plastic injected via the filler opening 119. After the melted plastic has cooled down, the upper mold half 11 is separated from the lower mold half 13, and the solidified plastic is removed. Thus, the plastic frame is obtained.

The above-described mold 1 can only be used to manufacture a plastic frame of one size. In order to manufacture another plastic frame of a different size, another different mold 1 is needed. Each different mold 1 needed for manufacturing a respective different-sized plastic frame contributes to the cost of manufacturing the different-sized plastic frames.

What is needed, therefore, is a mold that can overcome the above-described shortcomings.

### SUMMARY

In one preferred embodiment, a mold for manufacturing different-sized plastic frames simultaneously includes a first mold half and a second mold half. The first and second mold halves cooperatively define a first molding chamber and a second molding chamber, and the first molding chamber surrounds the second molding chamber.

Other aspects, novel features and advantages will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of at least one embodiment of the present invention. In the drawings, like reference numerals designate corresponding parts throughout various views, and all the views are schematic.

FIG. 1 is an isometric view of a mold for manufacturing different-sized first and second plastic frames according to a first embodiment of the present invention, the mold including an upper mold half and a lower mold half, the upper mold half including an upper mold core.

FIG. 2 is a side plan view of the mold of FIG. 1, showing internal features of the mold in phantom, and internal molding chambers with shading.

FIG. 3 is a bottom plan view of the upper mold core of FIG. 1, showing a bottom surface thereof with shading.

FIG. 4 is a side plan view of a mold for manufacturing different-sized first and second plastic frames according to a second embodiment of the present invention, the mold including an upper mold half and a lower mold half, and the upper mold half including an upper mold core, showing internal features of the mold in phantom, and internal molding chambers with shading.

FIG. 5 is a bottom plan view of the upper mold core of FIG. 4, showing a bottom surface thereof with shading.

FIG. 6 is an isometric view of a conventional mold for manufacturing a plastic frame, the mold including an upper mold half and a lower mold half, the upper mold half including an upper mold core.

FIG. 7 is a side plan view of the mold of FIG. 6, showing internal features of the mold in phantom.

FIG. 8 is a bottom plan view of the upper mold core of FIG. 6, showing a bottom surface thereof with shading.

### DETAILED DESCRIPTION OF PREFERRED EMBODIMENTS

Reference will now be made to the drawings to describe preferred and exemplary embodiments of the present invention in detail.

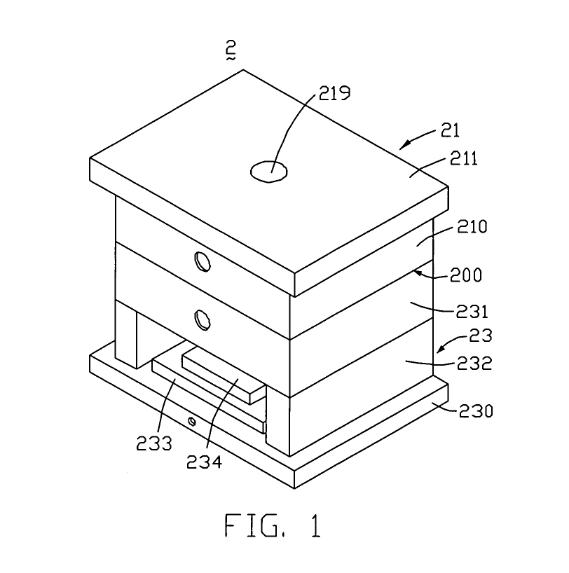

Referring to FIG. 1, a mold for manufacturing different-sized first and second plastic frames according to a first embodiment of the present invention is shown. The mold 2 includes an upper mold half 21 and a lower mold half 23 separated by an imaginary parting plane 200 therebetween.

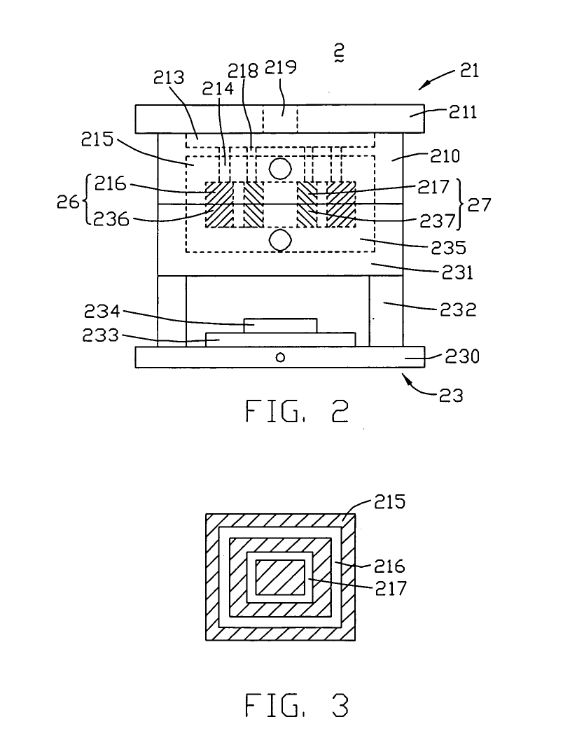

Referring also to FIG. 2, the lower mold half 23 includes a base plate 230, two supporting plates 232, a lower ejector plate 233, an upper ejector plate 234, a lower container 231, and a lower mold core 235. The base plate 230 supports the supporting plates 232, the lower ejector plate 233, and the upper ejector plate 234. The supporting plates 232 support the lower container 231, which in turn supports the lower mold core 235 and the upper mold half 21. The supporting plates 232 perpendicularly extend upwardly from two opposite sides of the base plate 230, and are substantially parallel to each other. The lower ejector plate 233 and the upper ejector plate 234 are arranged at the base plate 230 from bottom to top in that order, between the supporting plates 232. The upper ejector plate 234 has a smaller size than that of the lower ejector plate 233. The lower mold core 235 is fittingly received in the lower container 231, and has a first lower cavity 236 and a second lower cavity 237 defined therein. The first lower cavity 236 surrounds the second lower cavity 237, but is isolated from the second lower cavity 237.

Referring also to FIG. 3, the upper mold half 21 includes a top cover 211, an upper container 210, and an upper mold core 215. The top cover 211 includes a filler opening 219 defined therein. The upper mold core 215 is fittingly received in the upper container 210, and has a first upper cavity 216 and a second upper cavity 217 defined therein. The first upper cavity 216 surrounds the second upper cavity 217, but is isolated from the second upper cavity 217. The first upper cavity 216 corresponds to the first lower cavity 236, and the second upper cavity 217 corresponds to the second lower cavity 237. The upper container 210 includes a main runner 213, two first runners 214, and two second runners 218 defined therein. The main runner 213 is below the top cover 211, and communicates with the filler opening 219 and the first and second runners 214, 218. The first runners 214 further communicate with the first upper cavity 216, and the second runners 218 further communicate with the second upper cavity 217.

When the upper and lower mold halves 21, 23 are attached together, the first upper cavity 216 and the first lower cavity 236 cooperatively define a first molding chamber 26 corresponding to a shape of the first plastic frame (not shown), and the second upper cavity 217 and the second lower cavity 237 cooperatively define a second molding chamber 27 corresponding to a shape of the second plastic frame (not shown). The first molding chamber 26 surrounds the second molding chamber 27, but is isolated from the second molding chamber 27.

In operation, the different-sized first and second plastic frames can be manufactured as follows. First, melted plastic is injected into the main runner 213 via the filler opening 219, and is further filled in the first and second runners 214, 218. Second, the first molding chamber 26 is filled up with the melted plastic from the first runners 214, and the second molding chamber 27 is filled up with the melted plastic from the second runners 218. Third, the melted plastic in the first and second molding chambers 26, 27 is cooled down. Fourth, the upper mold half 21 is separated from the lower mold half 23. The solidified second plastic frame is ejected out by the upper ejector plate 234, and the solidified first plastic frame is ejected out by the lower ejector plate 233. Thus, the first and second plastic frames are obtained.

In summary, the mold 2 includes the first molding chamber 26, and the second molding chamber 27 surrounded by the first molding chamber 26. Therefore, the first and second plastic frames can be manufactured with the mold 2 at the same time. Unlike in conventional art, only a single mold 2 is needed for mass production of the first and second plastic frames. This can greatly reduce the cost of manufacturing the first and second plastic frames. Furthermore, because the first and second plastic frames are manufactured simultaneously, the efficiency of manufacturing is correspondingly improved.

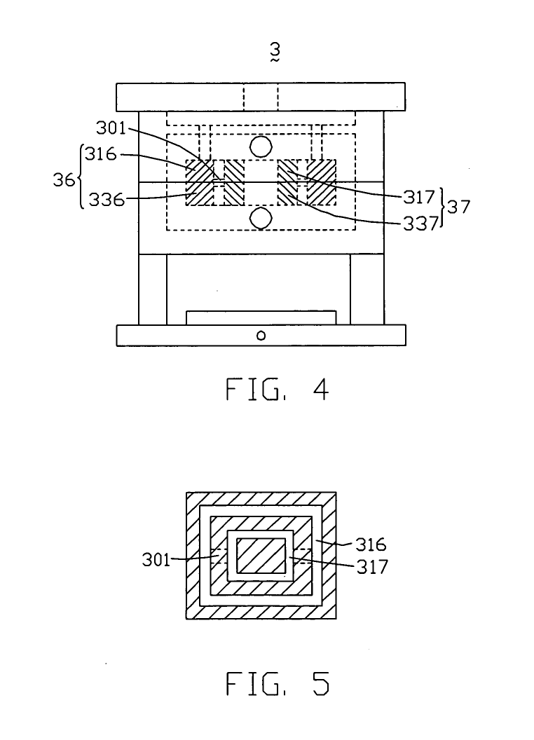

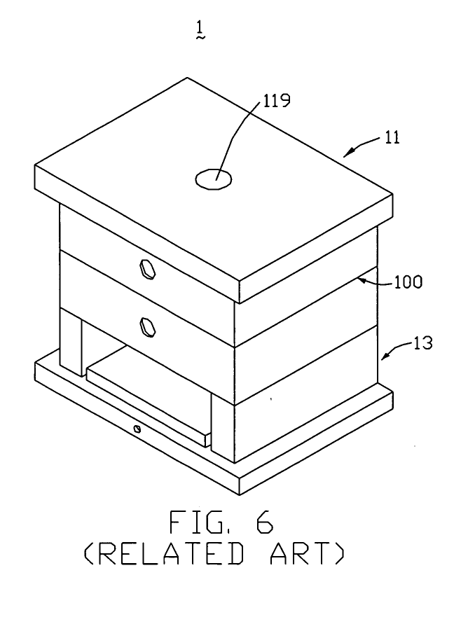

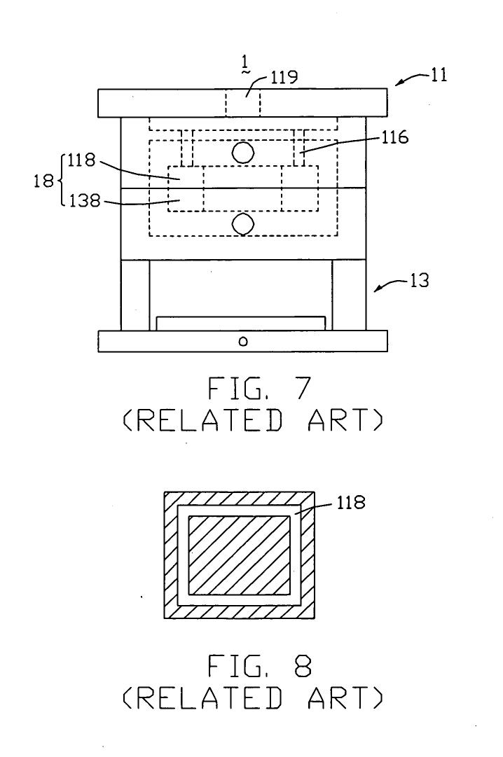

Referring to FIG. 4 and FIG. 5, a mold 3 for manufacturing different-sized first and second plastic frames according to a second embodiment of the present invention is similar to the mold 2. However, the mold 3 includes an upper mold half (not labeled) and a lower mold half (not labeled). The upper mold half includes a first upper cavity 316 and a second upper cavity 317 defined therein. The lower mold half includes a first lower cavity 336 and a second lower cavity 337 defined therein. The first upper cavity 316 and the first lower cavity 336 cooperatively define a first molding chamber 36 corresponding to a shape of a first plastic frame. The second upper cavity 317 and the second lower cavity 337 cooperatively define a second molding chamber 37 corresponding to a shape of a second plastic frame. The first molding chamber 36 surrounds the second molding chamber 37, and communicates with the second molding chamber 37 via a plurality of through channels 301, which through channels 301 are located at an imaginary parting plane (not labeled) of the mold 3. That is, the through channels 301 can be on an upper side of the parting plane, on an lower side of the parting plane, or straddle the parting plane. In the illustrated embodiment, the through channels 301 straddle the parting plane.

In manufacturing the first and second plastic frames, the first molding chamber 36 is filled up with melted plastic, and the second molding chamber 37 is also filled up with the melted plastic from the first molding chamber 36 via the through channels 301. The melted plastic in the first and second molding chambers 36, 37 and the through channels 301 is cooled down. The upper mold half is separated from the lower mold half. The solidified first and second plastic frames are ejected out simultaneously by an ejector plate (not labeled). Each of the first and second plastic frames is then cut away from where it is joined to portions of solidified plastic corresponding to the through channels 301. Thus, the individual first and second plastic frames are obtained. The mold 3 has a simple structure, insofar as fewer runners are required. In other respects, the mold 3 has features and advantages similar to those described above in relation to the mold 2.

Further or alternative embodiments may include the following. In a first example, the mold has no runners communicating with the first molding chamber. Instead, the mold has runners communicating with the second molding chamber; and the first and second molding chambers communicate with each other via through channels. In a second example, the mold includes three or more molding chambers, one surrounding the other in turn. The molding chambers can be isolated from each other, or can communicate with each other via through channels.

It is believed that the present embodiments and their advantages will be understood from the foregoing description, and it will be apparent that various changes may be made thereto without departing from the spirit or scope of the invention or sacrificing all of its material advantages, the examples hereinbefore described merely being preferred or exemplary embodiments of the invention.

What is claimed is:

1. A mold for manufacturing different-sized plastic frames simultaneously, the mold comprising:
a first mold half and a second mold half, wherein the first and second mold halves cooperatively define a first molding chamber and a second molding chamber, the first molding chamber surrounding the second molding chamber.

2. The mold as claimed in claim 1, wherein the first molding chamber is isolated from the second molding chamber.

3. The mold as claimed in claim 1, wherein the first mold half defines a first cavity, the second mold half defines a second cavity corresponding to the first cavity, and the first and second cavities cooperatively define the first molding chamber.

4. The mold as claimed in claim 3, wherein the first mold half defines a third cavity, the second mold half defines a fourth cavity corresponding to the third cavity, and the third and fourth cavities cooperatively define the second molding chamber.

5. The mold as claimed in claim 4, wherein first mold half comprises a filler opening, a main runner, a first runner, and a second runner defined therein, the main runner communicating with the filler opening, the first runner, and the second runner.

6. The mold as claimed in claim 5, wherein the first runner further communicates with the first molding chamber.

7. The mold as claimed in claim 6, wherein the first runner communicates with the first cavity.

8. The mold as claimed in claim 5, wherein the second runner further communicates with the second molding chamber.

9. The mold as claimed in claim 8, wherein the second runner communicates with the third cavity.

10. The mold as claimed in claim 1, wherein the first mold half comprises a runner communicating with the first molding chamber.

11. The mold as claimed in claim 11, wherein the first molding chamber communicates with the second molding chamber via a plurality of channels defined in at least one of the first mold half and the second mold half.

12. The mold as claimed in claim 1, wherein the second mold half comprises at least one ejector plate.

13. The mold as claimed in claim 12, wherein the at least one ejector plate comprises a first ejector plate and a second ejector plate, the first ejector plate corresponds to the first molding chamber, the second ejector plate corresponds to the second molding chamber, and the second ejector plate is smaller than the first ejector plate.

14. The mold as claimed in claim 12, wherein the second mold half further comprises a base plate supporting the at least one ejector plate.

15. The mold as claimed in claim 14, wherein the second mold half further comprises two supporting plates extending from two opposite sides of the base plate, the supporting plates supporting a part of the second mold half that includes portions of the first and second molding chambers.

16. The mold as claimed in claim 1, wherein the first mold half comprises a cover, and the cover defines the filler opening therein.

17. A mold for manufacturing different-sized plastic frames simultaneously, the mold comprising:
a first mold half defining a first cavity, and a second cavity surrounded by the first cavity; and
a second mold half defining a third cavity corresponding to the first cavity, and a fourth cavity corresponding to the second cavity, wherein the first and third cavities cooperatively define a first molding chamber configured for molding a larger sized plastic frame, and the second and fourth cavities cooperatively define a second molding chamber configured for molding a smaller sized plastic frame.

18. The mold as claimed in claim 17, wherein the first molding chamber communicates with the second molding chamber via a plurality of channels defined in at least one of the first mold half and the second mold half.

19. The mold as claimed in claim 17, wherein the first molding chamber is isolated from the second molding chamber.

20. A mold for manufacturing different-sized plastic frames simultaneously, the mold comprising:
a first mold half defining a plurality of first cavities with different sizes, at least one of the first cavities surrounding at least another one of the first cavities; and
a second mold half defining a plurality of second cavities respectively corresponding to the first cavities, each pair of corresponding first and second cavities defining a molding chamber having a particular size, with the sizes of the molding chambers being different from each other.
